(19) United States
(12) Patent Application Publication
(10) Pub. No.: US 2017/0098008 A1
(43) Pub. Date: Apr. 6, 2017

(54) MOBILE APPLICATION MANAGER SYSTEM AND METHOD

(71) Applicant: Squawqr LLC, Uniontown, OH (US)

(72) Inventor: Robert KEMMER, Littleton, NH (US)

(73) Assignee: Squawqr LLC, Uniontown, OH (US)

(21) Appl. No.: 15/286,157

(22) Filed: Oct. 5, 2016

Related U.S. Application Data
(60) Provisional application No. 62/237,863, filed on Oct. 6, 2015.

(51) Int. Cl. G06F 17/30; G06F 17/24

(52) U.S. Cl. CPC G06F 17/30896; G06F 17/30569; G06F 17/246; G06F 17/30589

(57) ABSTRACT

A mobile web application manager system is provided for creating, editing, and managing mobile web applications. The system may include an interface component configured to receive data in an arbitrary format. A formatting component may reformat the received data to a canonically formatted dataset. A publishing component may publish the canonically formatted dataset. A rendering component may render a mobile web application based on instructions and/or data comprised within the canonically formatted dataset.

### CROSS-REFERENCE TO RELATED APPLICATION

This application claims priority to U.S. Provisional Patent Application No. 62/237,863 filed on Oct. 6, 2015, the disclosure of which is incorporated by reference in its entirety.

### BACKGROUND AND SUMMARY

The present invention relates to an application manager system and, more particularly, to an application manager system that generates mobile web applications.

The proliferation, advancement, and affordability of mobile devices such as smartphones, tablets, and a wide variety of other electronic devices have made computers more available and prevalent to the general public than ever before. Mobile devices have become popular, at least in part, because users can easily customize devices by installing software programs, which are often referred to as mobile applications or “apps.” Apps are available and customized for many uses. For example, providers such as, retailers, brands, restaurants, and many others typically offer apps to consumers. These apps may give providers direct access to an interested user.

Along with the mobile applications, many who wish to reach users of mobile devices must provide mobile websites. These mobile websites are often different from traditional websites in appearance, functionality, and accessibility. Mobile websites and apps offer distinct advantages from one another. An app, once downloaded and installed on a user's mobile device, makes extensive use of on-board (or “native”) operating system resources and capabilities to provide a richly interactive user experience. Mobile websites offer the greater convenience of immediate web-browser access using only a Uniform Resource Locator (or “URL”) to branded or informational content and easily-accessed links to additional material without placing resource demands (such as memory consumption) on the user's mobile device.

In traditional systems, development of mobile applications is both time consuming and expensive. Further, development of mobile applications typically requires developers having extensive knowledge and skill in software development, and often in several computer programming languages. Mobile devices and operating systems, themselves, also compound these challenges with short life cycles.

Mobile apps (“native apps”) are compiled executables that must be written in a designated programming language (which varies by device), then downloaded to a user's device and installed in order to be used. As such, each app not only places inconvenient and potentially dissuasive demands on the end user in terms of memory-usage and installation procedures, but also executes exclusively in the environment for which it was written and compiled. This gives rise to a circumstance wherein, in order to serve users on a variety of popular devices (e.g. Android phones, iPhones, Blackberries, etc.), a separate code-base must be produced, distributed, and maintained for each targeted platform, requiring a programmer or team of programmers with sufficient diversity of skill and platform-specific knowledge to furnish end-users with comparable experiences on all targeted devices. Additionally, native mobile software is increasingly vulnerable to security exploitation in the form of computer viruses and malware.

Mobile websites are comprised of informational and branding content undesirably intertwined within markup language constructs (for example, HTML) that present the end-user with a web-page presentation that fits and behaves comfortably within the size constraints of a mobile device's web browser. As such, many mobile websites are wholly distinct from an organization's main website both in terms of content and user-experience, and consequently, must be maintained separately with additional scheduling, communication, effort, and coding to ensure consistency of content and branding. Lacking access to the underlying operating system's resources, mobile websites are also often less engaging and responsive in terms of user experience. This deficiency—and that of intertwining content within markup code—can be mitigated by the introduction of scripting elements (for example, JavaScript), but at the cost of additional complexity which, in turn, necessitates the retention of skilled programmers as well as website designers and webmasters.

Regardless, though, of which of these two models is selected, they both have common disadvantages. Since each requires specialized development and maintenance, changes to content from numerous sources (such as multiple departments, or a variety of individual contributors) can be difficult or impossible to implement in a suitably responsive manner without substantial procedural, communicative, and/or financial overhead. Also, while both can be crafted in such a way as to be “data-driven” (e.g., selecting and presenting content from a data repository in response to user interaction), any changes to the underlying data model—such as a change in name of a record's fields or the addition of new fields—can require extensive code changes. For an individual or organization without the financial wherewithal to support a specialized staff, this can be a formidable obstacle to providing and sustaining a satisfactory mobile user experience in response to changing business or organizational conditions.

Therefore, a need exists for improved systems and methods for creating, modifying, and managing mobile applications and mobile websites.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

An application manager system having various innovative features is provided herein. The application manager system may include an interface component, a formatting component, a publishing component, and a rendering component. The interface component may receive data in an arbitrary format that may be a non-canonical format. The formatting component may reformat the data to generate a canonically formatted dataset. The publishing component may publish the canonically formatted dataset. Consumers may access the canonically formatted dataset via user devices. The rendering component may initiate rendering, via the user devices, of a mobile web application based on the canonically formatted dataset.

A method for creating and managing mobile web applications is also provided. The method may receive non-canonically formatted data in an arbitrary format; format non-canonically formatted data into canonically formatted data; publish a mobile web application based on canonically formatted data; and render a user interface in response to receiving the canonically formatted data.

The following description and the drawings disclose various illustrative aspects. Some improvements and novel aspects may be expressly identified, while others may be apparent from the description and drawings.

### DESCRIPTION OF THE DRAWINGS

The accompanying drawings illustrate various systems, apparatuses, devices and methods, in which like reference characters refer to like parts throughout, and in which:

FIG. 1 is a functional block diagram of an application manager system in accordance with various embodiments described herein;

FIG. 2A is an exemplary spreadsheet worksheet including an application definition worksheet in accordance with various embodiments described herein;

FIG. 2B is an exemplary spreadsheet worksheet including a data feed worksheet in accordance with various embodiments described herein;

FIG. 3 is a functional block diagram of a canonical data structure in accordance with various embodiments described herein;

FIG. 4 is a diagram of an exemplary interface of a mobile web application in accordance with various embodiments described herein;

FIG. 5 is a diagram of another exemplary interface of a mobile web application rendered via a wearable device in accordance with various embodiments described herein;

FIG. 6 is a flow diagram of an exemplary method associated with an application manager system that may generate a mobile web application in accordance with various embodiments described herein;

FIG. 7 is an environmental diagram of an exemplary communication system in accordance with various embodiments disclosed herein; and

FIG. 8 is a block diagram of a functional computer system in accordance with various embodiments described herein.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Moreover, terms such as “access point,” “server,” and the likes, are utilized interchangeably, and refer to a network component or appliance that serves and receives control data, voice, video, sound, or other data-stream or signaling-stream. Data and signaling streams may be packetized or frame-based flows. Furthermore, the terms “end-user,” “customer,” “consumer,” and the like may be employed interchangeably throughout the subject specification, unless context suggests otherwise or warrants a particular distinction among the terms. It is noted that such terms may refer to human entities or automated components supported through artificial intelligence (e.g., a capacity to make inference). Still further, “user,” “customer,” “consumer,” may include a commercial establishment(s), business, organizations, individuals, or the like. For example, users may include a restaurant, a public agency, a small business, a single person, a group of people, or the like.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

A network typically includes a plurality of elements that host logic. In packet-based wide-area networks (WAN), servers (e.g., devices comprising logic) may be placed at different points on the network. Servers may communicate with other devices and/or databases. In another aspect, a server may provide access to a user account. The “user account” includes attributes for a particular user and commonly includes a unique identifier (ID) associated with the user. The ID may be associated with a particular device owned by the user. The user account may also include information such as relationships with other users, application usage, location, personal settings, files, permissions, and other information.

Embodiments may utilize substantially any wired or wireless network. For instance, embodiments may utilize various radio access network (RAN), e.g., Wi-Fi, global system for mobile communications, universal mobile telecommunications systems, worldwide interoperability for microwave access, enhanced general packet radio service, third generation partnership project long-term evolution (3G LTE), fourth generation long-term evolution (4G LTE), third generation partnership project 2, BLUETOOTH®, ultra mobile broadband, high speed packet access, xth generation long-term evolution, or another IEEE 802.XX technology.

It is noted that, terms “user equipment,” “device,” “user equipment device,” “client,” and the like are utilized interchangeably in the subject application, unless context warrants particular distinction(s) among the terms. Such terms may refer to a network component(s) that sends or receives data, voice, video, sound, or substantially any data-stream or signaling-stream to or from network components and/or other devices. By way of example, a user equipment device may comprise an electronic device capable of wirelessly sending and receiving data. A user equipment device may have a processor, a memory, a transceiver, an input, and an output. Examples of such devices include cellular telephones (e.g., smartphones), personal digital assistants (PDAs), portable computers, tablet computers (tablets), hand-held gaming counsels, wearables (e.g., smart watches), set top boxes, etc.

User equipment devices can communicate with each other and with other elements via a network, for instance, a wireless network, or a wireline network. A “network” can include broadband wide-area networks such as cellular networks, local-area networks, wireless local-area networks (e.g., Wi-Fi), and personal area networks, such as near-field communication networks including BLUETOOTH®. Communication across a network may include packet-based communications, radio and frequency/amplitude modulations networks, and the likes. Communication may be enabled by hardware elements called “transceivers.” Transceivers may be configured for specific networks and a user equipment device may have any number of transceivers configured for various networks. For instance, a smart phone may include a cellular transceiver, a Wi-Fi transceiver, a BLUETOOTH® transceiver, or may be hardwired. In those embodiments in which it is hardwired, any appropriate kind or type of networking cables may be utilized. For example, USB cables, dedicated wires, coaxial cables, optical fiber cables, twisted pair cables, Ethernet, HDMI and the like.

In traditional systems, development of mobile websites and apps require extensive knowledge, time, and monetary capital to create, manage, and maintain. Furthermore, given the rapidly changing mobile device landscape, mobile websites and apps must be diligently managed to maintain relevance and operability. In many instances, users that desire to offer a mobile website or native app do not have the time, money, or technical skill needed to create and manage such mobile websites or native apps. For example, a small business owner may wish to provide a mobile website and native app to its customers. This may allow the small business owner to directly communicate with interested customers, such as to provide specials, discount codes, advertisements, or the like. However, due to the business owner's limited capital and/or technical knowledge, the business owner may not be able to afford the time and costs of creating and maintaining a mobile website or native app.

Embodiments of the present disclosure may provide systems and methods that allow any user to efficiently create, modify, and maintain a mobile web application. In an aspect, an application manager system is provided. The application manager system may permit an unrestricted number of users to manage content and branding data for mobile web applications. The users need not possess knowledge of programming languages or methodologies to create and manage the mobile web applications.

Furthermore, the application manager system may provide data management in an interface that is convenient and familiar for any user, such as a business person having no or limited knowledge in native app development. In another aspect, the application manager system may provide updates to user devices (e.g., data updates, application updates, etc.) in real-time or near real-time. Moreover, the application manager system may provide for changes to the structure of data without requiring developers to code or manually implement such changes. In another aspect, formatting of the application data may accommodate different devices, operating systems, or the like. For instance, data from third-party sources can be incorporated into the mobile web application on-demand (e.g., in response to user interaction) by reference to ensure acceptable performance, rather than requiring the source to be pre-loaded at run-time.

According to at least one embodiment, the application management system may generate a mobile web application using input provided by a user. For instance, the application management system may provide an interface that allows a user to provide input, make selections, or otherwise enter data into a user device. The system may then create one or more mobile web application for distribution by the user (or a third-party). In an aspect, a user may easily manage the mobile web application by providing additional input and/or uploading an updated document (e.g., spreadsheet). For instance, the user may add features, change layouts, appearances, or the like without the need to edit code, utilize proprietary development tools/methodologies, or the like. Furthermore, the user may not need to download or install any software in order to generate the mobile web application.

It is noted that embodiments described herein may be generally robust or secure with respect to malicious code injections, attacks, hacking, or other security threats. In another aspect, the systems and methods of the present disclosure may provide a framework that is highly extensible, allowing for new features to be easily added and for existing features to be modified, such that the mobile web application may remain backwards-compatible.

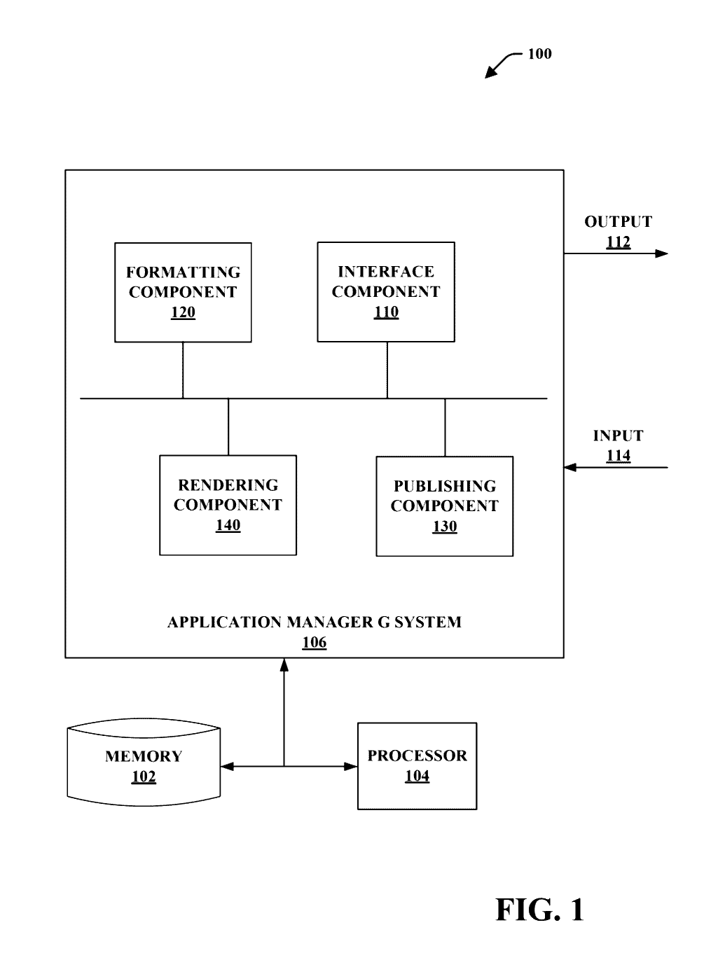

Referring now to FIG. 1, there depicted is a block diagram of a functional application manager system 100 that may generate and/or manage mobile web applications. Application manager system 100 may primarily include memory 102 and processor 104. Memory 102 may be configured for storing computer executable components such as an interface component 110, a formatting component 120, a publishing component 130, and a rendering component 140. Processor 104 may facilitate operation of the computer executable components. It is noted that system 100 may include one or more devices, such as a first user device, a server, and a second user device. It is further noted that one or more devices may comprise, at least in part, the various components. For instance, a single component of system 100 may be comprised by one or more devices. While shown as separate or distinct components, the components of system 100 may be comprised by one or more components.

Interface component 110 may receive and process non-canonical data as input 114. In an aspect, the non-canonical data may be received from a data store, user input, or the like. It is noted that interface component 110 may receive a file in various non-canonical or arbitrary formats. In an example, a user may enter data in a word processing document, spreadsheet document, or other type/form of document. The user may, via a user device, provide this document to interface component 110. Interface component 110 may receive the non-canonical data via secure or unsecure networking protocols. In an example, the interface component 110 may receive the data via HTTP/HTTPS connections, LDAP connections, TCP/IP socket connections, proprietary third-party networking components (“connectors”), BLUETOOTH® network connections, Near Field Communications (NFC) protocols, local system access (e.g., hard-disk drive, proprietary internal database connection, local operating system API, locally executing third-party software API, smart card, SD card, thumb-drive access, etc.), and the like. It is noted that the non-canonical data can be received via standard I/O mechanisms. According to at least one aspect, interface component 110 may receive input supplied by direct manual input (e.g. keyboard, digital pen, touch devices, etc.), voice recognition technology, or other input device.

Formatting component 120 may transform arbitrarily formatted or non-formatted data sets into canonically formatted data. The canonical data format may represent any type or depth of application data in a plain-text digital document, series of characters, or the like. In an aspect, a canonical data format may be utilized for an interchange of processing instructions. These instructions may instruct a user device to generate, execute, and/or populate mobile web applications.

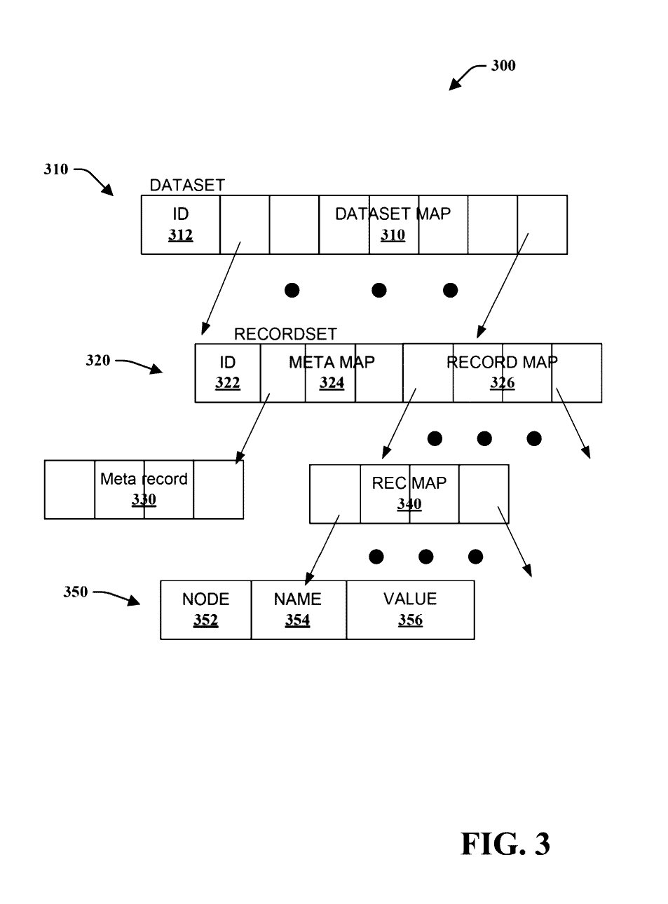

The canonical format may be configured to allow hierarchical datasets of limitless depth and recursion to be represented in a tabular format. For instance, a canonical format may include a dataset construct (e.g., a dataset). A dataset may represent a grouping of tabular data. The tabular data may be grouped into subsets, such as sets of records or recordsets. Nodes within the recordsets may be identified by name-value pairs. A “name” construct may represent a key portion of a name-value pair, while a value construct may represent the value portion of the name-value pair. For example, a dataset may comprise a group of tables, worksheets, or pages. A recordset may comprise rows/columns in the tables, rows in a worksheet, or specifications in a page. A node may include a grouping of rows/columns, cells in a worksheet, or the like. What has been described above may be further understood with reference to FIG. 3.

FIG. 3 depicts an exemplary structure 300 of a canonically formatted document. In at least one embodiment, a canonically formatted document may consist of a single un-named associative array 310. This array may be referred to as a dataset document. The dataset document may contain descendant elements, such as a dataset key or ID 312 and a dataset map 314. The dataset ID 312 may comprise an identifier that is unique within the system 100 and can be used to access or reference the dataset. The dataset map 314 may include an array or list of descendant elements. It is noted that dataset map 314 may contain any number of descendent elements (e.g., recordset 320). In at least one example, each recordset 320 may comprise a recordset ID 322, meta map 324, and a record map 326. The recordset ID 322 may uniquely identify the recordset 320 within the dataset map. The meta map 324 may comprise an associative array that may contain any number of descendant elements. Each element in the meta map 324 is an associative array, referred to as a meta record 330. A meta record 330 may contain an arbitrary data structure of indeterminate depth used to provide descriptions and instructions for the treatment of recordset data. The record map 326 may comprise any number of associative arrays. Each of the associative arrays within the record map 326 may be an un-named array 350 comprising three dependent elements, a node 352, a name 354, and a value 356. It is noted that this disclosure is not limited to the above canonically formatted structure and/or naming conventions. Rather, the above provides an exemplary canonically formatted data structure capable of tabular representation.

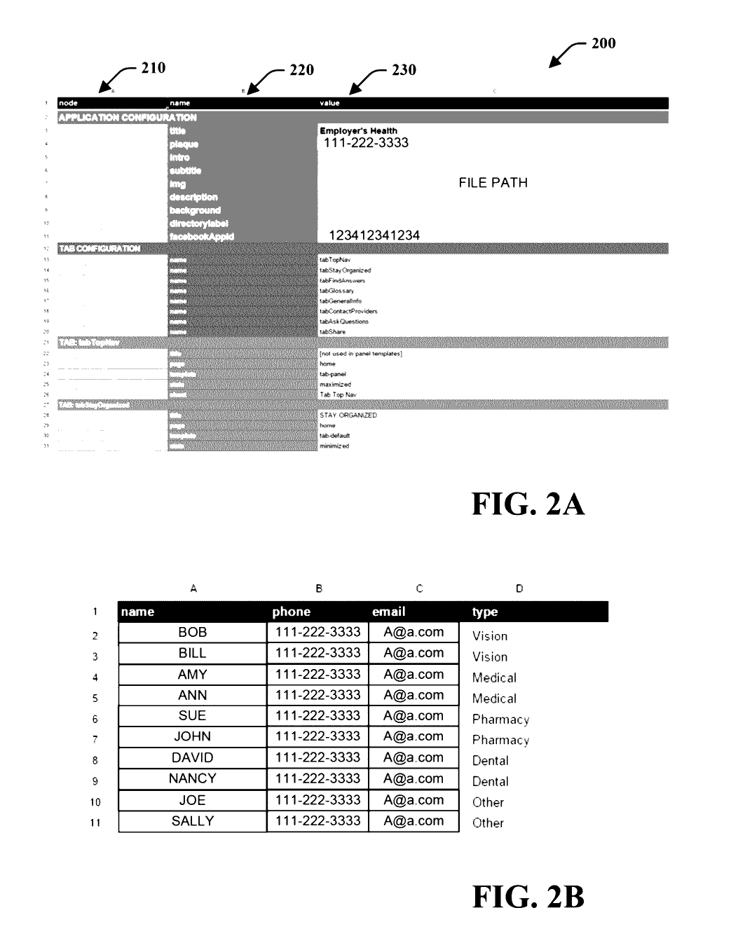

According to at least one embodiment, formatting component 120 may generate a canonical document from spreadsheets (e.g., worksheets 200 and/or 250 of FIGS. 2A and 2B) by reformatting the contents of the spreadsheets based on the structure 300. For instance, formatting component 120 may receive non-canonical formatted data, such as in a spreadsheet workbook, and can generate a canonical formatted document. This may allow system 100 to deliver non-canonical (arbitrarily-formatted) application data to rendering clients (e.g., user device) as canonically formatted interchange documents.

Formatting component 120 may provide facilities to locate data in any non-canonical format. A digital record may be assigned to a dataset document from which non-canonical data is to be produced. In an example, the system may assign an ID to a spreadsheet workbook. Each spreadsheet workbook may be assigned a unique ID. The digital record may additionally or alternatively comprise parameters associated with processing, converting, the dataset document. For instance, the digital record may comprise data associated with activation information. The activation information may be utilized to determine a period of time during which a dataset is eligible for interchange. The digital record may, additionally or alternatively, include account information that may uniquely identify one or more users to whom the originating non-canonical data and derivative associated dataset belong. For example, the account information may be associated with a user ID that is associated with one or more users. It is noted that the digital record may also identify ways data can be retrieved, which logical components are necessary to consume the non-canonical data, which logical components are necessary to validate the non-canonical data for structure and completeness, and/or which logical components are necessary to transform the data from non-canonical to canonical format.

In at least one embodiment, formatting component 120 may validate the non-canonical data. For instance, the formatting component 120 may analyze contents of a spreadsheet workbook to determine whether the contents is sufficient to populate a valid dataset document, as described with reference to FIG. 3. Prior to and/or during validation, the formatting component 120 may place the non-canonical data in a short-term volatile memory cache. If the data is insufficient, the formatting component 120 may discord the document from which the non-canonical data is produced. In another aspect, the formatting component 120 may notify a user (e.g., via a user device) that the document comprises invalid properties. When notifying the user, formatting component 120 may additionally or alternatively identify solutions or steps for the user to take to rectify the invalid properties.

A valid non-canonical document may be transformed from an arbitrary format into a canonical format, such as that described by structure 300. It is noted that the formatting component 120 may determine a file type and/or format of the non-canonical document. Based on the type or format, the formatting component 120 may perform an appropriate process to automatically convert (e.g., without user intervention) the non-canonical document. In an aspect, non-canonical data determined to have been presented in well-known interchange format may be converted into canonical format using a “pull” model of document construction by engaging appropriate processing code components in the system. For example, non-canonical data in XML format is transformed using open-source XML parsing libraries using either SAX processing, DOM processing, or XSLT transformation. Non-canonical data in JSON format is transformed using open-source parsing libraries and proprietary mapping processes. Non-canonical data in LDIF (LDAP Directory Interchange Format) is transformed using open-source parsing libraries and proprietary mapping algorithms. Non-canonical data in comma-delimited or tab-delimited format is transformed using proprietary streaming delimited parsing or open-source delimited parsing. Non-canonical data in digital format corresponding to well-known spreadsheet or word-processing formats are transformed using open-source parsing libraries. Non-canonical data in unknown or exotic formats, or in formats for which no open-source parsing libraries are currently available in the public domain, are transformed using custom built parsing modules coded and configured to conform to the system's proprietary component model.

It is noted that formatting component 120 may modify, add, replace, or otherwise alter data in a canonically formatted document. For instance, formatting component 120 may augment data based on preconfigured presentation requirements that vary by user interface-type selection. In an example, meta map 324 elements (e.g., meta record 330) may be injected into the recordsets 320 of a dataset 310. The meta record 330 may be altered based on a triggering event, such as when relevant data is encountered during or after transformation. Such may provide for automatically generating a fully canonically formatted document that may be rendered by and/or may instruct a user device to generate a mobile web application.

Canonical format data may be cached in a memory (e.g., memory 102). According to at least one embodiment, the data may be cached based on preconfigured service-level parameters, such that prepared dataset documents are cached for quick retrieval. It is noted that system 100 may monitor frequency of use of datasets to alter (e.g., improve) efficiency and latency of different data sets. For instance, infrequently used datasets are kept in a short-term “read-through” cache, requiring their underlying non-canonical data sources to be reprocessed on-demand when a “cache-miss” occurs to TTL expiration. Frequently used datasets may be kept in a long-term cache that only refreshes when explicitly triggered by a user (e.g., a data-owner) or administrative action, such as when a user updates a dataset.

Publishing component 130 may distribute or publish canonically formatted data as a mobile web application. In an aspect, publishing component 130 may receive a request and/or respond to requests (e.g., via output 112) for access to a mobile web application via any appropriate network, such as HTTP, HTTPS, Bluetooth, and/or NFC. In another aspect, publishing component 130 may respond to requests for a valid dataset in a MIME type requested by the rendering client (e.g., JSON, HTML, XML, LDIF, CSV or Tab-delimited, and/or Custom delimited). The canonically formatted data may facilitate generation and execution of mobile web-based application by a user device without requiring the user device to download and install a native operating system file. For example, native apps often require a consumer to initiate downloading of an executable file from an online store or third party. This executable file is then installed on the user's device. In contrast, publishing component 130 may transmit the generated canonical data as a mobile web application that may comprise an HTML5/JavaScript/CSS or other application configured to be rendered and scripted via a web browser of a user device. Such web browsers may be native to an operating system on the device.

Turning to FIGS. 2A-2B, with reference to FIGS. 1 and 3, illustrated are exemplary non-canonical documents or worksheets 200 and 250 that may be converted to a canonically formatted document. While examples provide a non-canonical document in a spreadsheet form, it is noted that various other non-canonical forms may be used.

These worksheets 200 and 250 may comprise tabulated forms or templates. In an aspect, worksheet templates may be pre-created with appropriate structure to satisfy the requirements for transformation of the non-canonical data into a canonical data format. In an example, a spreadsheet workbook may comprise any number of worksheets. A spreadsheet itself may be associated with a complete dataset construct in the canonical data format. According to at least one embodiment, interface component 110 may assign an identifier (ID) or key value to each spreadsheet. A key value may include a name, location, address, and/or system-associated unique ID of the spreadsheet.

Each worksheet (e.g., worksheets 200 and 250) in the spreadsheet's workbook corresponds and/or may be converted to a single recordset construct (e.g., recordset 320) in the canonical format's dataset array using the owner-supplied name, spreadsheet-application's internal index, and/or ID of the worksheet. A recordset's ID value may comprise the name, index, internal ID, location, or other suitable contextually unique identifier. With reference now to FIG. 2A, worksheet 200 may comprise columns that may allow for conversion of the worksheet 200 to a canonically formatted dataset. For instance, worksheet 200 may comprise a node column 210, a name column 220, and a value column 230. The node column 210 may be mapped to node 352 of a record map 340, the name column 220 may be mapped to name 354, and the value column 230 may be mapped to value 356. In an aspect, worksheet 200 may comprise an application definition worksheet that may define a structure of a mobile web application. Worksheet 250 may comprise a data feed worksheet that may comprise data to be rendered in a user interface.

In another aspect, the worksheets 200 and 250 may be associated with a spreadsheet workbook. The spreadsheet workbook may contain a root worksheet with a reserved name or ID that is capable of being identified as an initialization recordset. For instance, the root worksheet may be mapped to dataset ID 312. Dataset documents resulting from the processing of spreadsheet workbooks are decoded at the recordset level (e.g., recordset 320) by insertion of meta map 324 elements (e.g., meta record 330) encountered by parsing well-known node and name values.

In an aspect, spreadsheets may be stored in a memory device (e.g., memory 102). For instance, spreadsheets may store in local storage of a computing device, in remote or cloud-based storage or the like. Interface component 110 may receive and store, as local spreadsheet files, spreadsheets produced by commercial or open-source productivity suites, exported from third-party software products, or the like. In another aspect, interface component 110 may store and/or receive cloud-based spreadsheets via cloud-provider URL's via HTTP, provided identifiers using third-party network connectors, or other methods. In an example, a user may create, edit, and save a spreadsheet file via a third-party service, such as an online document editing suite. Such local and/or cloud-based spreadsheets may be received by interface component 110 and may be associated with existing valid datasets and/or new datasets.

Utilization of formatted and/or templated spreadsheets may allow users to easily manage, create, and/or edit mobile web applications. User's need not possess knowledge of programming languages, different operating systems (e.g., operating systems of various different smart phone providers), databases, or the like. In another aspect, user's will not need to go through third parties (e.g., mobile web application stores) to alter (e.g., update, modify, etc.) their mobile web applications.

In at least one embodiment, application management component 100 may receive Directory Information Trees (DITs) as a non-canonical source of application data. The application management component 100 may generate canonical datasets and/or files from the DITs, as described herein. For instance, LDAP Directory Interchange Format (LDIF) files may be pre-created with an appropriate and/or recommended structure and mapping facilities to produce or exemplify a structure necessary to satisfy the requirements for canonical transformation. A mapping facility is associated with both the valid dataset and the target Distinguished Name (DNs) in the DIT that will be used to construct the dataset document, as described with reference to FIG. 3. Map entries provide mapping guidance for which additional DN's will act as the root configuration recordset for the rendering client on a user device. Map entries provide aliasing for native X.500 names as recordset names and “id” elements, well-known configuration node and name rendering parameters, and/or to node, name, and value construct “leafs” in the DIT.

Continuing with the above example, the system 100 (e.g., via formatting component 120) may set a combination of the fully qualified domain name (“FQDN” and the target domain name (“DN”) as the “key” element (e.g., dataset ID 312) in the dataset document. Each immediate child node depending from the target DN node corresponds to a single recordset construct (e.g., recordset 320) in the canonical format's dataset. Each immediate child node depending from a recordset's corresponding DN node is mapped to a node, name, or value construct (e.g., entry of record map 340) in the canonical format using the mapping facility. It is noted that dataset documents resulting from the processing of a DIT may be decorated at the recordset level (e.g., 320) by the insertion of meta map 324 elements (e.g., meta records 330) encountered by parsing well-known node and name values.

Formatting component 120 may receive files in DIT structures and transform them to appropriate canonically formatted data files (e.g., as described with reference to FIG. 3). For DIT's that support remote access via LDAP, open source libraries and proprietary parsing processes may be utilized to construct the canonically formatted datasets. For DIT's that do not support remote access via LDAP, an LDIF export of the target DN may be uploaded to the system or consumed on-demand over another network protocol.

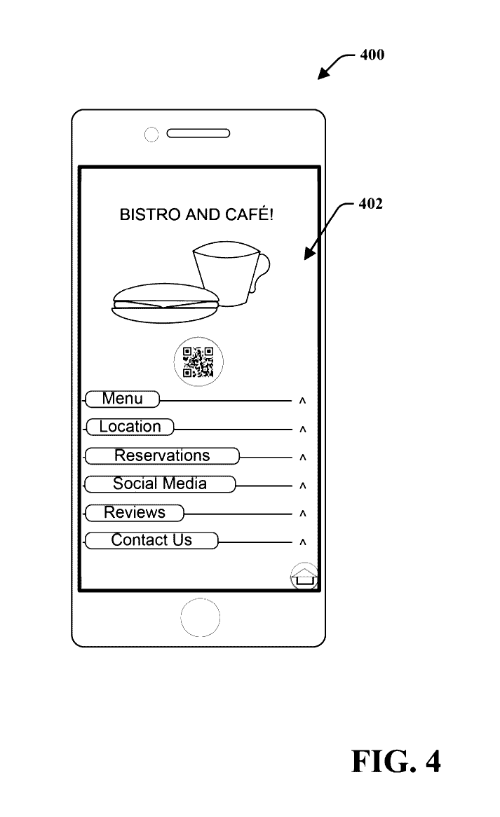

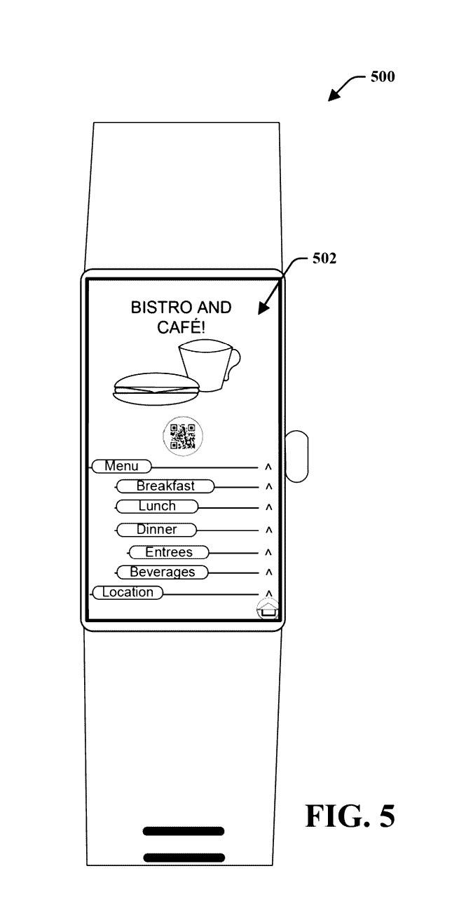

Rendering component 140 may receive canonically formatted application data and may render the canonically formatted application data into a user interface suitably constructed to perform with a high degree of consistency on a wide variety of devices. For example, FIGS. 4 and 5 depict user devices 400 and 500 respectively. Each user device 400 and 500 may comprise disparate devices (e.g., different makes/models) that may run different operating systems. As shown, application manager system 100 may enable user device 400 to render interface 402 and may enable user device 500 to render interface 502. Interfaces 402 and 502 are shown in a tabulated and/or hierarchical layout. It is noted, however, that other layouts may be utilized. In another aspect, the interfaces 402 and 502 may be highly customizable and/or may provide for various tools, recourse links, plugins, and the like. For instance, interfaces may comprise links to external URL, SMS (text-messaging) sharing, e-mail contacts, e-mail sharing, mapping services (e.g., navigation services), social media systems, 2-Dimensional bar codes (e.g., QUICK RESPONSE (“QR”)), links to activate features of a device (e.g., voice calling, video communications, etc.) or the like.

In embodiments, rendering component 140 may establish and deliver a variety of rendering-logic controls appropriate to the type of dataset being rendered. It is noted that rendering component 140 may associate any portion of a URL with a single valid dataset. In response to receiving a rendering-logic request associated with a valid dataset, rendering component 140 may produce a dynamically generated container document or manifest referencing resources required to render the desired user interface. Resource requests, such as references to the key of the associated dataset, libraries, styling instructions, and custom rendering components if so configured, may be subsequently requested—either from the network or from a local caching mechanism—as prompted in the container document or manifest to render the user interface (“UI”).

In an aspect, rendering component 140 (e.g., via a user device) may render datasets into suitable UI presentations for a given device. For example, rendering component 140 may render a UI for a smartphone (e.g., user device 400), for a wearable device (e.g., user device 500), or other make/model of device. It is noted that rendering component 140 may render disparate UI presentations for similar types of devices (e.g., smartphone, wearable, set top box, etc.). For instance, different smartphones may comprise different operating systems, display capabilities, processor capabilities, or the like. Logic loaded by the dataset's container document or manifest establishes the type of device into which the UI will be rendered to establish a parametric description of the device. Rendering component 140 may receive a dataset at a user device. The user device may utilize open-source, customer proprietary, and third-party licensed proprietary libraries in response to both the dataset and a parametric device description to produce a UI with a high degree of consistency relative to the same dataset rendered on other devices.

Rendering component 140 may cache dataset documents on a rendering client's memory store. In an aspect, when a rendering-client requests a valid dataset, the rendering component 140 may first query a client-side cache. If the dataset is present, the client-side cache may service the request. Once and/or during loading of the client-side cached dataset, rendering component 140 may generate background network request to determine if a more recent revision of the dataset is available. If a more recent revision of the dataset is available, the cached revision is discarded and the UI is triggered to prompt the user as to whether a reload of the UI is desired immediately or on next-use. In another aspect, if the requested dataset is not available in the cache, a new network request is made for the dataset.

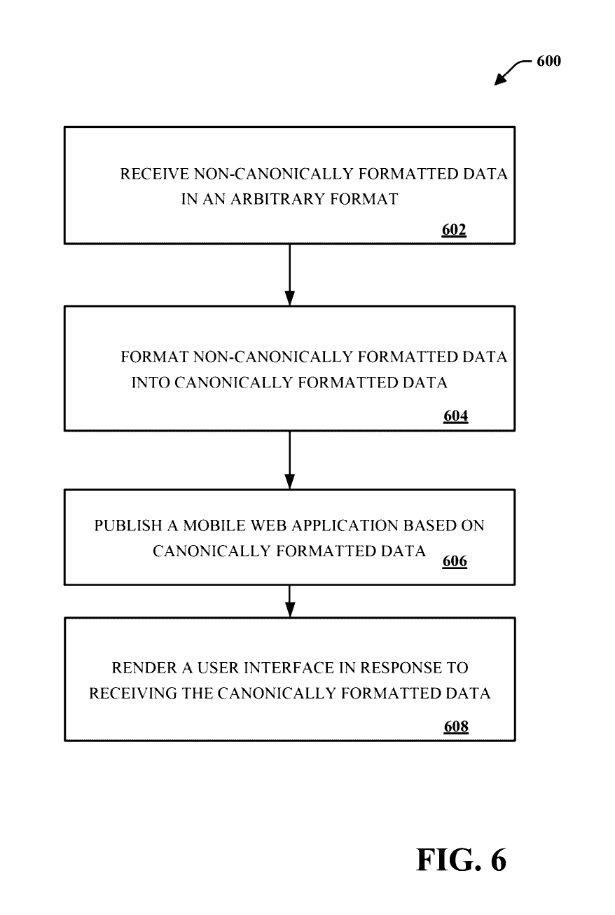

In view of the subject matter described herein, a method that may be related to various embodiments may be better appreciated with reference to the flowchart of FIG. 6. While the method is shown and described as a series of blocks, it is noted that the method is not limited by the order of the blocks. It is further noted that some blocks and corresponding actions may occur in different orders or concurrently with other blocks. Moreover, different blocks or actions may be utilized to implement the methods described hereinafter. Various actions may be completed by one or more of users, devices, machines (e.g., including one or more processors or computing devices), or the like.

FIG. 6 depicts an exemplary flowchart of non-limiting method 600 associated with an application manager system that may generate a robustly compatible mobile web application, according to various aspects of the subject disclosure. As an example, method 600 may receive a spreadsheet workbook from a user and, based on the spreadsheet workbook, generate a mobile web application accessible by one or more consumers.

At 602, method 600 may receive, by a system (e.g., via interface component 110), non-canonically formatted data in an arbitrary format. The non-canonically formatted data may be received from a local memory store, a database, a cloud-computing network, direct user input, or the like. In an example, receiving the non-canonically formatted data may include receiving spreadsheet workbooks, DITs, word processing documents, text files, or the like. It is noted that the non-canonically formatted data may be comprised in a document type that is generally widespread and familiar to average users. For instance, various word processor document types may be utilized. This may allow any user to easily create and manage the non-canonical data.

At 604, method 600 may format, by the system (e.g., via formatting component 120) non-canonically formatted data into canonically formatted data. Formatting the non-canonical data may comprise, for example, assigning an ID and/or generating a digital file with a unique ID, receiving the non-canonical data via a communications framework, validating the received data, converting the non-canonical data into a canonical format, augmenting the canonical formatted data with appropriate commands/data, and/or storing a canonical data file. In an aspect, the canonically formatted data may be stored in a memory device, such as memory 102.

At 606, method 600 may publish, by the system (e.g., via publishing component 130), a mobile web application based on canonically formatted data. Publishing the mobile web application may include uploading, transmitting, or otherwise making the mobile web application available for download and/or consumption by user devices. In an aspect, publishing may include assigning a URL code, QR, or other identifier to the mobile web application.

At 608, method 600 may render, by the system (e.g., via rendering component 140), a user interface in response to receiving the canonically formatted data. For instance, a consumer may access the mobile web application via a user device. The user device may, based on instructions receiving from rendering component 140, generate a UI. The UI may include controls, modules, recourse links, embedded media (e.g., videos, audio, still images, etc.), and/or various other desired features.

While embodiments describe receiving non-canonically formatted data, it is noted that systems and methods described herein may receive canonically formatted data in an arbitrary format. The systems and methods may allow for conversion of the arbitrary formatted document to a document format appropriate for the system and methods, such as described with reference to FIG. 3.

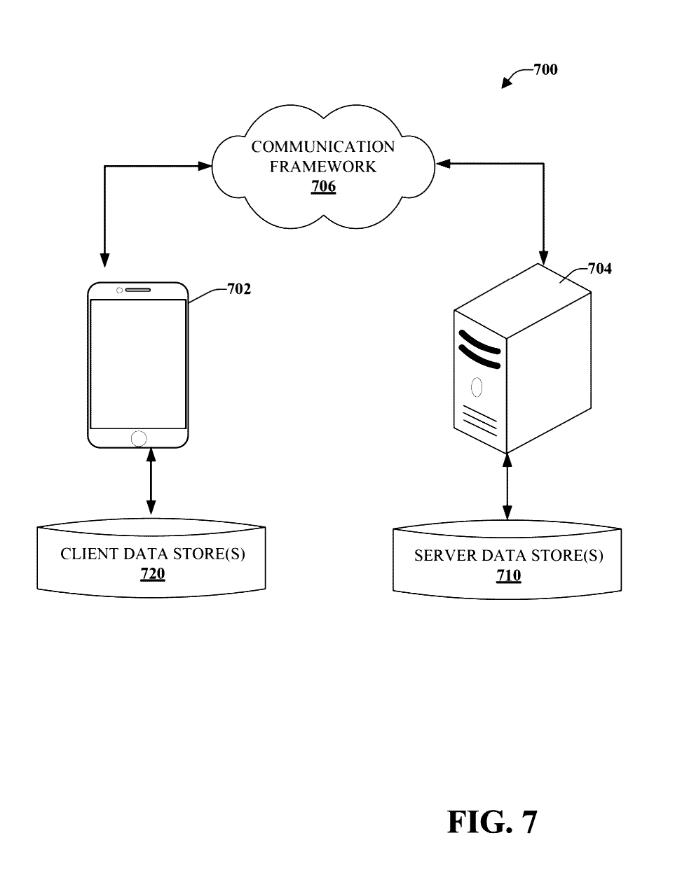

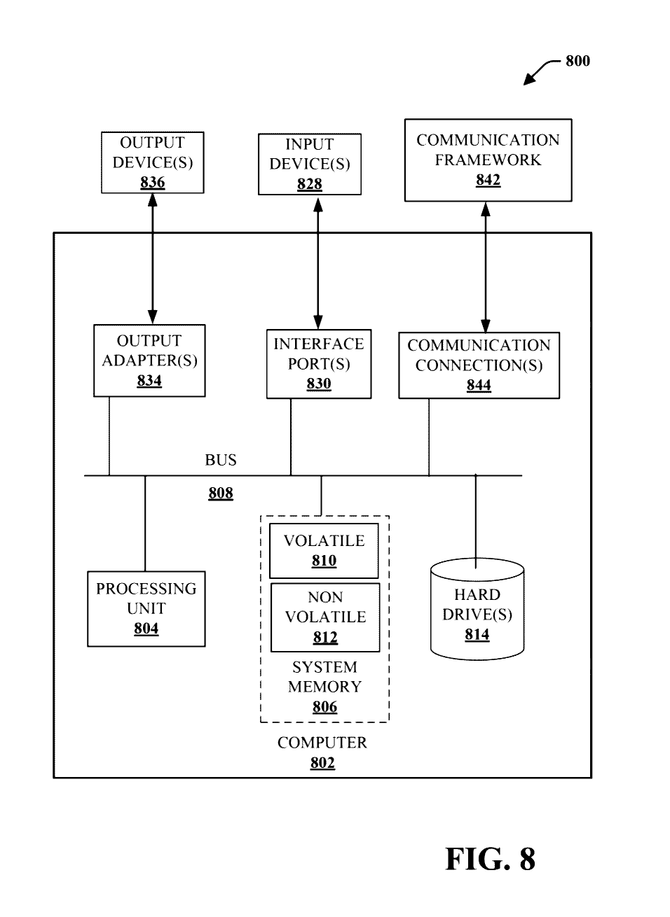

What has been described above may be further understood with reference to the following figures. FIGS. 7 and 8 provide exemplary operating environments or systems capable of implementing one or more systems, apparatuses, or processes described above. FIGS. 7 and 8 are not intended to limit the scope of such systems, apparatuses, or processes. By way of example, computing environment 700 may refer to one or more embodiment of the various embodiments described with reference to the above figures. However, variations to computing environment 700 may be obvious to achieve aspects or processes described herein.

FIG. 7 is a schematic diagram of a computing environment 700 in accordance with various disclosed aspects. It is noted that environment 700 may include various other components or aspects. As depicted, system 700 may include one or more client(s) 702, one or more server(s) 704, one or more client data store(s) 720, one or more server data store(s) 710, and a communication framework 706.

While depicted as a desktop computer(s), client(s) 702 may include various other devices that may comprise hardware and/or software (e.g., program threads, processes, computer processors, non-transitory memory devices, etc.). In an example, client(s) 702 may include smart phones, tablet computers, set top devices, gaming counsels, handheld gaming devices, wearables, etc.). The client(s) 702 may include or employ various aspects disclosed herein. For example, client(s) 702 may include or employ all or part of various systems (e.g., system 100) and processes disclosed herein. In an aspect, client(s) 702 may generate a request for a mobile web application. In another aspect, client(s) 702 may receive and render a mobile web application.

Likewise, server(s) 704 may include various devices that may comprise hardware and/or software (e.g., program threads, processes, computer processors, non-transitory memory devices, etc.). Server(s) 704 may include or employ various aspects disclosed herein. For example, server(s) 704 may include or employ all or part of various systems (e.g., system 100) and processes disclosed herein. It is noted that server(s) 704 and client(s) 702 may communicate via communication framework 706. In an exemplary communication, client(s) 702 and server(s) 704 may utilize packeted data (e.g., data packets) adapted to be transmitted between two or more computers. For instance, data packets may include coded information associated with a canonical dataset, user information, or the likes. For example, server(s) 704 may receive non-canonical datasets, generate canonical data files, and/or transmit canonical data to client(s) 702.

Communication framework 706 may comprise various network devices (e.g., access points, routers, base stations, etc.) that may facilitate communication between client(s) 702 and server(s) 704. It is noted various forms of communications may be utilized, such as wired (e.g., optical fiber, twisted copper wire, etc.) and/or wireless (e.g., cellular, Wi-Fi, near field communication, etc.) communications.

In various embodiments, client(s) 702 and server(s) 704 may respectively include or communicate with one or more client data store(s) 720 or one or more server data store(s) 710. The data stores may store data local to client(s) 702 or server(s) 704. It is noted that one or more client data store(s) 720 or one or more server data store(s) 710 may store canonical data, non-canonical data, or other data files.

FIG. 8 is a block diagram of a computer system 800 that may be employed to execute various disclosed embodiments. It is noted that various components may be implemented in combination with computer executable instructions, hardware devices, and/or combinations of hardware and software devices that may be performed by computer system 800.

Computer system 800 may include various components, hardware devices, software, software in execution, and the likes. In embodiments, computer system 800 may include computer 800. Computer 800 may include a system bus 808 that couples various system components. Such components may include a processing unit(s) 804, system memory device(s) 806, disk storage device(s) 814, sensor(s) 835, output adapter(s) 834, interface port(s) 830, and communication connection(s) 844. One or more of the various components may be employed to perform aspects or embodiments disclosed herein. In an aspect, the computer system 800 may “learn,” such as described above user preferences based upon modifications of recipes by users, through rating of recipes both positively and negatively. For example, the computer system 800 may modify a particular recipe (or a set thereof) as the majority of users or supermajority thereof have disapproved of the recipe (such as for taste, texture, consistency, temperature, or a variety of these factors). The computer system 800 may dynamically push out the revised recipe or receive the revised recipe as applicable.

Processing unit(s) 804 may comprise various hardware processing devices, such as single core or multi-core processing devices. Moreover, processing unit(s) 804 may refer to a “processor,” “controller,” “computing processing unit (CPU),” or the likes. Such terms generally relate to a hardware device. Additionally, processing unit(s) 804 may include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or the likes.

System memory 806 may include one or more types of memory, such volatile memory 810 (e.g., random access memory (RAM)) and non-volatile memory 812 (e.g., read-only memory (ROM)). ROM may include erasable programmable ROM (EPROM), electrically erasable programmable ROM (EEPROM). In various embodiments, processing unit(s) 804 may execute computer executable instructions stored in system memory 806, such as operating system instructions and the likes.

Computer 802 may also include one or more hard drive(s) 814 (e.g., EIDE, SATA). While hard drive(s) 814 are depicted as internal to computer 802, it is noted that hard drive(s) 814 may be external and/or coupled to computer 802 via remote connections. Moreover, input port(s) 830 may include interfaces for coupling to input device(s) 828, such as disk drives. Disk drives may include components configured to receive, read and/or write to various types of memory devices, such as magnetic disks, optical disks (e.g., compact disks and/or other optical media), flash memory, zip drives, magnetic tapes, and the likes.

It is noted that hard drive(s) 814 and/or other disk drives (or non-transitory memory devices in general) may store data and/or computer-executable instructions according to various described embodiments. Such memory devices may also include computer-executable instructions associated with various other programs or modules. For instance, hard drives(s) 814 may include operating system modules, application program modules, and the likes. Moreover, aspects disclosed herein are not limited to a particular operating system, such as a commercially available operating system.

Input device(s) 828 may also include various user interface devices or other input devices, such as sensors (e.g., microphones, pressure sensors, light sensors, etc.), scales, cameras, scanners, facsimile machines, and the likes. A user interface device may generate instructions associated with user commands. Such instructions may be received by computer 802. Examples of such interface devices include a keyboard, mouse (e.g., pointing device), joystick, remote controller, gaming controller, touch screen, stylus, and the likes. Input port(s) 830 may provide connections for the input device(s) 828, such as via universal serial ports (USB ports), infrared (IR) sensors, serial ports, parallel ports, wireless connections, specialized ports, and the likes.

Output adapter(s) 834 may include various devices and/or programs that interface with output device(s) 836. Such output device(s) 836 may include LEDs, computer monitors, touch screens, televisions, projectors, audio devices, printing devices, or the likes.

In embodiments, computer 802 may be utilized as a client and/or a server device. As such, computer 802 may include communication connection(s) 844 for connecting to a communication framework 842). Communication connection(s) 844 may include devices or components capable of connecting to a network. For instance, communication connection(s) 844 may include cellular antennas, wireless antennas, wired connections, and the likes. Such communication connection(s) 844 may connect to networks via communication framework 842. The networks may include wide area networks, local area networks, facility or enterprise wide networks (e.g., intranet), global networks (e.g., Internet), satellite networks, and the likes. Some examples of wireless networks include Wi-Fi, Wi-Fi direct, BLUETOOTH®, Zigbee, and other 802.XX wireless technologies. It is noted that communication framework 842 may include multiple networks connected together. For instance, a Wi-Fi network may be connected to a wired Ethernet network.

The terms “component,” “module,” “system,” “interface,” “platform,” “service,” “framework,” “connector,” “controller,” or the like are generally intended to refer to a computer-related entity. Such terms may refer to at least one of hardware, software, or software in execution. For example, a component may include a computer-process running on a processor, a processor, a device, a process, a computer thread, or the likes. In another aspect, such terms may include both an application running on a processor or a processor itself Moreover, such terms may be localized to one computer and/or may be distributed across multiple computers.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define application manager system 100. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile web application manager system, comprising:
a processor;
a computer readable memory device storing computer executable instructions that cause a processor to execute or facilitate execution of acts, the acts comprising:
receiving data in an arbitrary format;
reformatting the data to a canonically formatted dataset;
publishing the canonically formatted dataset; and
initiating rendering of a mobile web application based on the canonically formatted dataset.

2. A mobile web application manager system, comprising:
an interface component configured to receive data in a non-canonical format;
a formatting component configured to reformat the received data to a canonically formatted dataset;
a publishing component configured to publish the canonically formatted dataset; and
a rendering component configured to render a mobile web application based on the canonically formatted dataset.

3. The system of claim 2, wherein the received data in the non-canonical format comprises a spreadsheet, and the formatting component is configured to reformat contents of the spreadsheet into the canonically formatted data.

4. The system of claim 3, wherein the spreadsheet comprises an application definition worksheet that defines a structure of the mobile web application, and at least one data worksheet that includes the non-canonically formatted data to be rendered in the mobile web application.

5. The system of claim 2, wherein the interface component is further configured to receive input from a user on a user device.

6. The system of claim 2, wherein the rendering component is configured to render the mobile web application in a web browser.

7. The system of claim 2, wherein the canonically formatted data comprises processing instructions, and the rendering component renders the mobile web application based on the processing instructions of the canonically formatted data.

8. The system of claim 2, wherein the canonically formatted data is configured in a canonical format configured for hierarchical datasets to be represented in a tabular format.

9. The system of claim 8, wherein hierarchical datasets includes an arbitrary depth and recursion.

10. The system of claim 2, wherein the formatting component is further configured to reformat the non-canonically formatted data as canonically formatted interchange documents.

11. The system of claim 2, wherein the formatting component is configured to pull non-canonically formatted data that was previously received, based on a request from the rendering component to render the mobile web application.

12. The system of claim 2, wherein the formatting component comprises a custom built parsing module configured to reformat the non-canonically formatted data.

13. The system of claim 2, wherein the rendering component is further configured to dynamically generate a container document to render the canonically formatted data in the mobile web application.

14. The system of claim 2, wherein the rendering component is configured to produce a user interface with a high degree of consistency when rendered on multiple different devices.

15. A method for creating and managing mobile web applications comprising the steps of:
receiving non-canonically formatted data in an arbitrary format;
formatting non-canonically formatted data into canonically formatted data;
publishing a mobile web application based on the canonically formatted data; and
rendering a user interface in response to receiving the canonically formatted data.
